(19) United States
(12) Patent Application Publication
(10) Pub. No.: US 2025/0223526 A1
(43) Pub. Date: Jul. 10, 2025

(54) BLEACH SHEETS AND CONTAINER THEREFOR

(71) Applicant: Patricia Mendoza, Tucson, AZ (US)

(72) Inventor: Patricia Mendoza, Tucson, AZ (US)

(21) Appl. No.: 18/408,186

(22) Filed: Jan. 9, 2024

(51) Int. Cl. C11D 17/06; A47K 10/42; C11D 3/395

(52) U.S. Cl. CPC C11D 17/06; A47K 10/42; C11D 3/3953; C11D 2111/12

(57) ABSTRACT

A laundry-whitening product, including a container, including an opening to allow access into the container, and a dispensing seal to selectively seal the opening of the container; and a plurality of bleach sheets stored within the container, the plurality of bleach sheets including a whitening agent dispersed throughout and contained within each of the plurality of bleach sheets in a predetermined amount.

### BACKGROUND

### 1. Field

The present general inventive concept relates generally to a bleach product, and particularly, to bleach sheets and a container therefor.

### 2. Description of the Related Art

“Bleach” is the generic name for any chemical product that is used industrially or domestically to remove color (whitening) from fabric or fiber (in a process called bleaching) or to disinfect after cleaning. It often refers specifically to a dilute solution of sodium hypochlorite, also called “liquid bleach”.

Many bleaches have broad-spectrum bactericidal properties, making them useful for disinfecting and sterilizing. They are used in swimming pool sanitation to control bacteria, viruses, and algae and in many places where sterile conditions are required. They are also used in many industrial processes, notably in the bleaching of wood pulp. Bleaches also have other minor uses, like removing mildew, killing weeds, and increasing the longevity of cut flowers.

Bleaches work by reacting with many colored organic compounds, such as natural pigments, and turning them into colored ones. While most bleaches are oxidizing agents (chemicals that can remove electrons from other molecules), some are reducing agents (that donate electrons).

Chlorine, a powerful oxidizer, is the active agent in many household bleaches. Since pure chlorine is a toxic corrosive gas, these products usually contain hypochlorite, which releases chlorine. “Bleaching powder” usually refers to a formulation containing calcium hypochlorite.

Oxidizing bleaching agents that do not contain chlorine are usually based on peroxides, such as hydrogen peroxide, sodium percarbonate, and sodium perborate. These bleaches are called “non-chlorine bleach”, “oxygen bleach”, or “color-safe bleach”.

Reducing bleaches have niche uses, such as sulfur dioxide, which is used to bleach wool, either as gas or from solutions of sodium dithionite, and sodium borohydride.

Bleaches generally react with many other organic substances besides the intended colored pigments, so they can weaken or damage natural materials like fibers, cloth, and leather, and intentionally applied dyes, such as the indigo of denim. For the same reason, ingestion of the products, breathing of the fumes, or contact with skin or eyes can cause bodily harm and damage health.

Also, when a user desires to wash clothes using bleach, the user often adds too much or too little bleach, thereby causing a load of laundry to either not receive enough bleach, or alternatively, too much bleach resulting in wasted bleach product.

Therefore, there is a need for a product that allows for a predetermined and correct amount of bleach to be added to a load of laundry in a convenient, eco-friendly, and safe manner.

### SUMMARY

The present general inventive concept provides bleach sheets and a container therefor.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a laundry-whitening product, including a container, including an opening to allow access into the container, and a dispensing seal to selectively seal the opening of the container, and a plurality of bleach sheets stored within the container, the plurality of bleach sheets including a whitening agent dispersed throughout and contained within each of the plurality of bleach sheets in a predetermined amount.

The whitening agent may be removed from at least one of the plurality of bleach sheets when the at least one of the plurality of bleach sheets is submerged in water, such that the water becomes concentrated with the whitening agent.

The whitening agent may be at least one of bleach, chlorine, hypochlorite, sodium hypochlorite, calcium hypochlorite, hydrogen peroxide, sodium percarbonate, and sodium perborate.

The plurality of bleach sheets may be stored within the container in an accordion-style manner, such that each of the plurality of bleach sheets are removable from the container through the dispensing seal of the opening at a rate of one bleach sheet at a time.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front and top side perspective view of plurality of bleach sheets stored within a container, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Laundry Whitening Product 1
Bleach Sheets 100
Whitening Agent 110
Container 200
Opening 210
Dispensing Seal 211

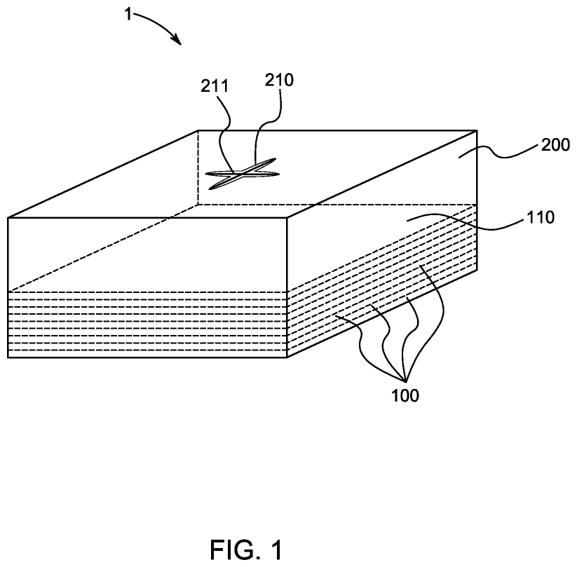

FIG. 1 illustrates a front and top side perspective view of plurality of bleach sheets 100 stored within a container 200, according to an exemplary embodiment of the present general inventive concept.

The plurality of bleach sheets 100 may be constructed from at least one of cellulose fibers, wood, hemp, or any other material that is insoluble or soluble in water.

The container 200 and all components therewithin may be constructed from at least one of plastic, carbon, wood, metal, hemp, and rubber, etc., but is not limited thereto.

A combination of the container 200 having the plurality of bleach sheets 100 stored therein may be collectively referred to as a laundry whitening product 1.

Referring to FIG. 1, the container 200 may include an opening 210 and a dispensing seal 211 that may deform to allow a user extract an item stored within the container 200 out through the opening 210, while still maintaining a relatively water-tight seal when not in use.

Referring to FIG. 1, the plurality of bleach sheets 100 may be stored within the container 200 in an accordion-style manner, such that when the user desires to extract one of the plurality of bleach sheets 100 from the container 200, only one of the plurality of bleach sheets 100 is extracted at a time.

Each one of the plurality of bleach sheets 100 is concentrated with an equivalent of approximately ¼ cup of whitening agent 110. In other words, each one of the plurality of bleach sheets 100 may include a predetermined amount of the whitening agent 110, which can take the form of bleach, chlorine, hypochlorite, sodium hypochlorite, and/or calcium hypochlorite, such that the whitening agent 110 distributed throughout and/or concentrated within each of the plurality of bleach sheets 100.

The present general inventive concept describes the plurality of beach sheets 100 as being concentrated with bleach. However, the present general inventive concept is not limited thereto, and the plurality of beach sheets 100 may be concentrated with oxidizing bleaching agents that do not contain chlorine that are based on peroxides, such as hydrogen peroxide, sodium percarbonate, and sodium perborate, which are also known as “non-chlorine bleach”, “oxygen bleach”, or “color-safe bleach”.

When the user desires to add a whitening agent and/or whitening liquid (i.e., bleach) to a load of laundry (e.g., a load of white laundry) in a washing machine, the user may extract a first sheet of the plurality of bleach sheets 100 from the opening 210 of the container 200, such that a small portion of a second sheet of the plurality of bleach sheets 100 is caught by the dispensing seal 211 after the first sheet of the plurality of bleach sheets 100 is fully extracted from the container 200.

The user may then add the first sheet of the plurality of bleach sheets 100 to the load of laundry.

As the laundry is washed by the washing machine, the whitening agent 110 that is stored within the first sheet of the plurality of bleach sheets 100 is removed by water and agitation of the washing machine, such that the whitening agent 110 is distributed among the laundry disposed within the washing machine.

The first sheet of the plurality of bleach sheets 100 may then later be removed from the load of laundry after the washing machine is finished, or alternatively, may be removed from the load of laundry after it is dried by air or a dryer.

Alternatively, the plurality of bleach sheets 100 may be made from a water-soluble material that dissolves in water (e.g., warm water).

The present general inventive concept may include a laundry-whitening product 1, including a container 200, including an opening 210 to allow access into the container 210, and a dispensing seal 211 to selectively seal the opening 210 of the container 200, and a plurality of bleach sheets 100 stored within the container 200, the plurality of bleach sheets 100 including a whitening agent 110 dispersed throughout and contained within each of the plurality of bleach sheets 100 in a predetermined amount.

The whitening agent 110 may be removed from at least one of the plurality of bleach sheets 100 when the at least one of the plurality of bleach sheets 100 is submerged in water, such that the water becomes concentrated with the whitening agent 110.

The whitening agent 110 may be at least one of bleach, chlorine, hypochlorite, sodium hypochlorite, calcium hypochlorite, hydrogen peroxide, sodium percarbonate, and sodium perborate.

The plurality of bleach sheets 100 may be stored within the container in an accordion-style manner, such that each of the plurality of bleach sheets 100 are removable from the container 200 through the dispensing seal 211 of the opening 210 at a rate of one bleach sheet at a time.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A laundry-whitening product, comprising:
a container, comprising;
an opening to allow access into the container, and
a dispensing seal to selectively seal the opening of the container; and
a plurality of bleach sheets stored within the container, the plurality of bleach sheets comprising:
a whitening agent dispersed throughout and contained within each of the plurality of bleach sheets in a predetermined amount.

2. The laundry-whitening product of claim 1, wherein the whitening agent is removed from at least one of the plurality of bleach sheets when the at least one of the plurality of bleach sheets is submerged in water, such that the water becomes concentrated with the whitening agent.

3. The laundry-whitening product of claim 1, wherein the whitening agent is at least one of bleach, chlorine, hypochlorite, sodium hypochlorite, calcium hypochlorite, hydrogen peroxide, sodium percarbonate, and sodium perborate.

4. The laundry-whitening product of claim 1, wherein the plurality of bleach sheets are stored within the container in an accordion-style manner, such that each of the plurality of bleach sheets are removable from the container through the dispensing seal of the opening at a rate of one bleach sheet at a time.
